(19) United States
(12) Patent Application Publication
(10) Pub. No.: US 2024/0072956 A1
(43) Pub. Date: Feb. 29, 2024

(54) SYSTEMS AND METHODS OF CONFIGURING REDUCED REPETITIONS FOR UWB PHYSICAL LAYER HEADERS

(71) Applicant: Meta Platforms Technologies, LLC, Menlo Park, CA (US)

(72) Inventors: Carlos Horacio Aldana, Mountain View, CA (US); Qiyue Zou, Elk Grove, CA (US); Abhishek Kumar Agrawal, Bellevue, WA (US); Chunyu Hu, Saratoga, CA (US); Kangjin Yoon, Menlo Park, CA (US); Claudio Rafael Cunha Monteiro da Silva, Kirkland, WA (US); Carlos Bocanegra Guerra, Santa Clara, CA (US)

(73) Assignee: Meta Platforms Technologies, LLC, Menlo Park, CA (US)

(21) Appl. No.: 18/238,245

(22) Filed: Aug. 25, 2023

Related U.S. Application Data
(60) Provisional application No. 63/401,502, filed on Aug. 26, 2022.
(60) Provisional application No. 63/419,569, filed on Oct. 26, 2022.

(51) Int. Cl. H04L 5/00; H04L 1/00

(52) U.S. Cl. CPC H04L 5/0044; H04L 1/0063

(57) ABSTRACT

Systems and methods for configuring reduced repetitions for ultra-wideband (UWB) physical layer headers may include a first UWB device that generates a packet including a first header and a second header. The first header may include a plurality of bits indicating a data rate and an encoding scheme of a payload of the packet. The first UWB device may transmit the packet to a second UWB device. The second UWB device may receive and decode the packet according to the encoding scheme and the data rate.

### CROSS-REFERENCE TO RELATED APPLICATIONS

This application claims the benefit of and priority to U.S. Provisional Application No. 63/401,502, filed Aug. 26, 2022, and U.S. Provisional Application No. 63/419,569, filed Oct. 26, 2022, the contents of each of which are incorporated by reference in their entirety.

### FIELD OF DISCLOSURE

The present disclosure is generally related to sensing and ranging, including but not limited to systems and methods for configuring repetitions for ultra-wideband physical layer headers.

### BACKGROUND

Ultra-wideband (UWB) technology provides for precise ranging between two devices having UWB devices or transceivers. Some devices may include UWB sensors as well as antennas/systems for supporting other types of wireless transmission technology outside of UWB (e.g., out-of-band), such as Wi-Fi, cellular, Bluetooth, etc.

### SUMMARY

Various embodiments disclosed herein are related to systems and methods for configuring ultra-wideband physical layer headers (PHRs). The systems and methods described herein can configure UWB PHRs to relay, convey, signal, or otherwise provide information relating to various configurations or implementations of the connection between devices. For example, the UWB PHRs may provide information on whether a frame is to be used for ranging, sensing, whether low density parity check (LDPC) is enabled or disabled, a version, a modulation coding scheme (MCS), or any other configuration information.

In one aspect, this disclosure is directed to a method. The method may include generating, by a first ultra-wideband (UWB) device, a packet including a first header and a second header. The first header may include a plurality of bits indicating a data rate and an encoding scheme of a payload of the packet. The method may include transmitting, by the first UWB device, the packet to a second UWB device.

In some embodiments, the plurality of bits indicate whether low density parity check (LDPC) or constraint length 7 (CL7) encoding scheme is used by the first UWB device. In some embodiments, the plurality of bits indicate the data rate of the payload and the second header. In some embodiments, the packet includes two repetitions of the first header and the second header. In some embodiments, the first header is encoded at a data rate which is different than the data rate of the payload indicated by plurality of bits. In some embodiments, the second header is encoded at a data rate which is half of the data rate of the payload indicated by the plurality of bits. In some embodiments, the method may include selecting, by the first UWB device, the data rate for encoding the payload. In some embodiments, the data rate is selected from a range of data rates between 1.95 Mb/s and 124.8 Mb/s. In some embodiments, the second header includes one or more bits indicating whether the packet is to be used for sensing or ranging. In some embodiments, the second header includes one or more bits indicating a payload length of the payload and a plurality of parity bits, wherein a number of the plurality of parity bits is determined according to an 8-bit cyclic redundancy check.

In another aspect, this disclosure is directed to a first device. The first device may include an ultra-wideband (UWB) transceiver configured to generate a packet including a first header and a second header. The first header may include a plurality of bits indicating a data rate and an encoding scheme of a payload of the packet. The UWB transceiver may be configured to transmit the packet to a second UWB device.

In some embodiments, the plurality of bits indicate whether low density parity check (LDPC) or constraint length 7 (CL7) encoding scheme is used by the first device. In some embodiments, the plurality of bits indicate the data rate of the payload and the second header. In some embodiments, the packet includes two repetitions of the first header and the second header. In some embodiments, the first header is encoded at a data rate which is different than the data rate of the payload indicated by plurality of bits. In some embodiments, the second header is encoded at a data rate which is half of the data rate of the payload indicated by the plurality of bits. In some embodiments, the UWB transceiver is further configured to select the data rate for encoding the payload. In some embodiments, the data rate is selected from a range of data rates between 1.95 Mb/s and 124.8 Mb/s. In some embodiments, the second header includes one or more first bits indicating whether the packet is to be used for sensing or ranging, one or more second bits indicating a payload length of the payload, and a plurality of parity bits, wherein a number of the plurality of parity bits is determined according to an 8-bit cyclic redundancy check.

In yet another aspect, this disclosure is directed to a first ultra-wideband (UWB) transceiver including one or more processors configured to receive, from a second UWB transceiver, a packet including a first header and a second header. The first header may include a plurality of bits indicating a data rate and an encoding scheme of a payload of the packet. The one or more processors may be configured to decode the packet according to the encoding scheme and the data rate.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of an artificial reality environment, according to an example implementation of the present disclosure.

FIG. 4 is a block diagram of another artificial reality environment, according to an example implementation of the present disclosure.

FIG. 5 is a block diagram of another artificial reality environment, according to an example implementation of the present disclosure.

FIG. 6 is a block diagram of a computing environment, according to an example implementation of the present disclosure.

FIG. 7 is a block diagram of a system for configuring reduced repetitions for ultra-wideband physical layer headers, according to an example implementation of the present disclosure.

FIG. 8 depicts various examples of UWB packets which may be generated by a device of the system of FIG. 7, according to an example implementation of the present disclosure.

FIG. 9 depicts a portion of the UWB packets of FIG. 8, including a plurality of headers and payload, according to an example implementation of the present disclosure.

FIG. 10 is a flowchart showing a method of configuring reduced repetitions for ultra-wideband physical layer headers, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to Figures, a packet (such as a scrambled timestamp sequence (STS)) packet, may include a synchronization header (SHR), a physical layer packet header (PHY header, or a physical layer packet header (PHR)), and a physical layer payload or data unit (PSDU). The PHR may provide a mechanism in which a device can signal to a second device properties or parameters of the remainder of the received packet. For example, the physical layer packet header can signal how many bytes of data are included in the payload, whether the packet is a ranging packet, and so forth. In some embodiments, the PHR may be configured to be repeated to have lower data rates. By having lower data rates, the robustness of the PHR may be increased, thereby reducing a likelihood that the PHR may be a bottleneck (particularly where LDPC is enabled for the packet). The PHR may be repeated any number of times. In some embodiments, the PHR may be split into multiple PHRs.

According to various embodiments of the present disclosure, a first ultra-wideband (UWB) device may generate a packet including a first header and a second header. The first header may include a plurality of bits indicating a data rate and an encoding scheme of a payload of the packet. The first UWB device may transmit the packet to the second UWB device. In some embodiments, the first PHR may signal, indicate, or otherwise provide a data rate of both the second PHR and the payload. The first PHR may indicate the data rate and encoding scheme used to encode the packet, and the second PHR may indicate, for example, whether the payload is to be used for ranging/sensing, the payload length, and provide error correction (e.g., parity bits). Such implementations may reduce an overhead associated with sending one PHR at a reduced data rate, while still ensuring the fidelity of the PHRs. Additional details of the present disclosure, as well as advantages of the present disclosure, are described in greater detail below.

Disclosed herein are embodiments related to devices operating in the ultra-wideband (UWB) spectrum. In various embodiments, UWB devices (including pucks, anchors, UWB beacons, UWB antennas, etc.) operate in the 3-10 GHz unlicensed spectrum using 500+ MHz channels which may require low power for transmission. For example, the transmit power spectral density (PSD) for some devices may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices within a shared or common environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

Some implementations of UWB may focus on precision ranging, security, and low to moderate rate data communication. For example, employing UWB devices as described herein allows for a determination of a relative location between two or more UWB devices with precision (e.g., determination of devices within 5-10 degrees of rotation and a distance within 0.5 mm). The determination of the location, position, tilt, and/or rotation of UWB devices relative to one another enables, among other features, clear spatial audio content to be communicated between the UWB devices (and/or between multiple other devices such as a first device and any peripheral devices). Spatial audio, in some aspects, refers to three-dimensional audio, where three-dimensional audio describes the phenomenon/situation of audio emanating from (or appearing to emanate from) various locations. In some embodiments, the audio signal may seem to originate within objects. In contrast to spatial content, head-locked content refers to content that is fixed with respect to a user. For example, a user wearing a head wearable device (HWD) configured with spatial audio capabilities may experience audio behind the user, in front of the user, above the user, to the side of the user, below the user, and so on. In contrast, a user wearing a HWD configured with head-locked rotation may experience a fixed audio sound emanating from a fixed location, regardless of the user's rotation/movement in an environment.

In some embodiments, sensors (e.g., inertial measurement units, magnetometers, cameras, etc.) can provide head locked rotation data corresponding to the movement and/or orientation of the sensors or an associated object. However, such collected sensor data may be affected by signal drift. Moreover, the collected sensor data may be limited in its ability to provide/maintain accurate positions in space. Additionally, the collected sensor data may be limited in its capacity to describe the distance of objects relative to position and rotations relative to other objects. In some embodiments, sensor data may be used in conjunction with such techniques as virtual reality simultaneous localization and mapping (VR SLAM) and object detection to enable spatial audio content to be communicated. However, utilizing a sensor such as a camera to facilitate spatial audio content implies that the camera would always be on, consuming excessive power and utilizing real estate on a limited space device (e.g., a head wearable device).

As UWB employs relatively simple modulation, it may be implemented at low cost and low power consumption. Accordingly, UWB devices may be employed to track movement and/or orientation so as to support, process and/or communicate spatial audio content. In AR/VR applications, link budget calculations for an AR/VR controller link indicate that the systems and methods described herein may be configured for effective data throughput ranging from −2 to 31 Mbps (e.g., with 31 Mbps being the maximum possible rate in the latest 802.15.4z standard), which may depend on body loss assumptions. Using conservative body loss assumptions, the systems and methods described herein should be configured for data throughput of up to approximately 5 Mbps, which may be sufficient to meet the data throughput performance standards for AR/VR links. With a customized implementation, data throughput rate could be increased beyond 27 Mbps (e.g., to 54 Mbps), but with a possible loss in link margin.

Using UWB allows one or more devices to determine their relative distance to one another. The determination of a relative distance from a device can be used to anchor a user in a digital/physical/audio environment. Accordingly, spatial audio content can be output from a known source location (e.g., an audio source) and be received by a user coupled to a device based on the position/orientation of the user coupled to the device and the audio source. In some embodiments, sensors (such as IMUs and magnetometers) may collect data in conjunction with data collected from UWB devices to achieve a high sample rate relative to the determined location and/or rotation. Various applications, use cases, and further implementations of the systems and methods described herein are described in greater detail below.

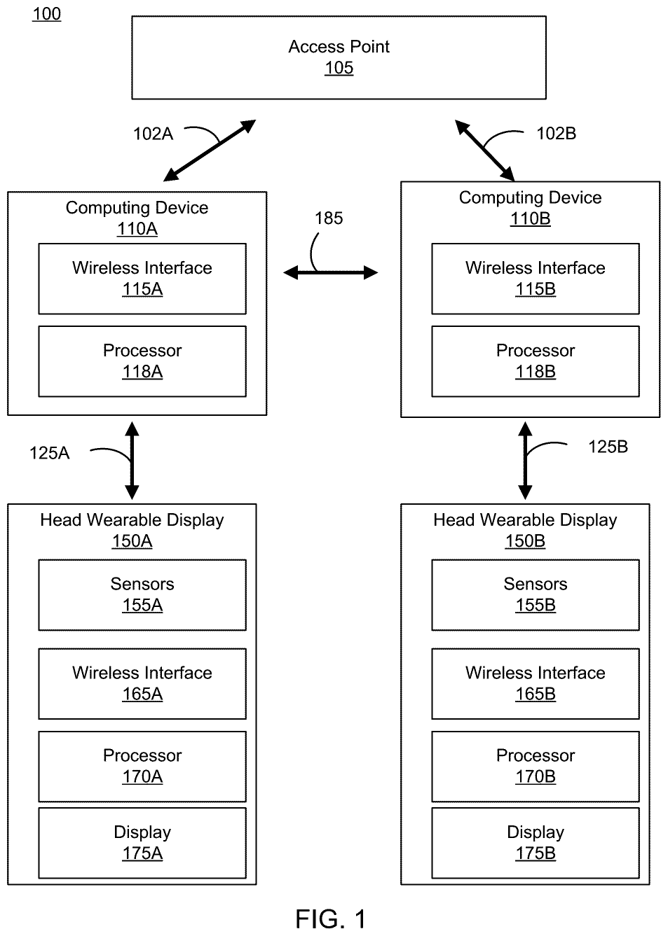

FIG. 1 is a block diagram of an example artificial reality system environment 100. In some embodiments, the artificial reality system environment 100 includes an access point (AP) 105, one or more HWDs 150 (e.g., HWD 150A, 150B), and one or more computing devices 110 (computing devices 110A, 110B; sometimes referred to as devices or consoles) providing data for artificial reality to the one or more HWDs 150. The access point 105 may be a router or any network device allowing one or more computing devices 110 and/or one or more HWDs 150 to access a network (e.g., the Internet). The access point 105 may be replaced by any communication device (cell site). A computing device 110 may be a custom device or a mobile device that can retrieve content from the access point 105, and provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the access point 105 through a wireless link (e.g., interlink). Examples of the wireless link 125 include a near field communication link, Wi-Fi direct, Bluetooth, or any wireless communication link. In some embodiments, the wireless link 125 may include one or more ultra-wideband communication links, as described in greater detail below. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the access point 105 through a wireless link 102 (e.g., interlink). Examples of wireless link 102 include a cellular communication link, a near field communication link, Wi-Fi, Bluetooth, 60 GHz wireless link, ultra-wideband link, or any wireless communication link. The wireless interface 115 may also include a component to communicate with a different computing device 110 through a wireless link 185. Examples of the wireless link 185 include a near field communication link, Wi-Fi direct, Bluetooth, ultra-wideband link, or any wireless communication link. Through the wireless link 102 (e.g., interlink), the wireless interface 115 may obtain AR/VR content, or other content from the access point 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118, 170 may configure or cause the wireless interfaces 115, 165 to toggle, transition, cycle or switch between a sleep mode and a wake up mode. In the wake up mode, the processor 118 may enable the wireless interface 115 and the processor 170 may enable the wireless interface 165, such that the wireless interfaces 115, 165 may exchange data. In the sleep mode, the processor 118 may disable (e.g., implement low power operation in) the wireless interface 115 and the processor 170 may disable the wireless interface 165, such that the wireless interfaces 115, 165 may not consume power or may reduce power consumption. The processors 118, 170 may schedule the wireless interfaces 115, 165 to switch between the sleep mode and the wake up mode periodically every frame time (e.g., 11 ms or 16 ms). For example, the wireless interfaces 115, 165 may operate in the wake up mode for 2 ms of the frame time, and the wireless interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced.

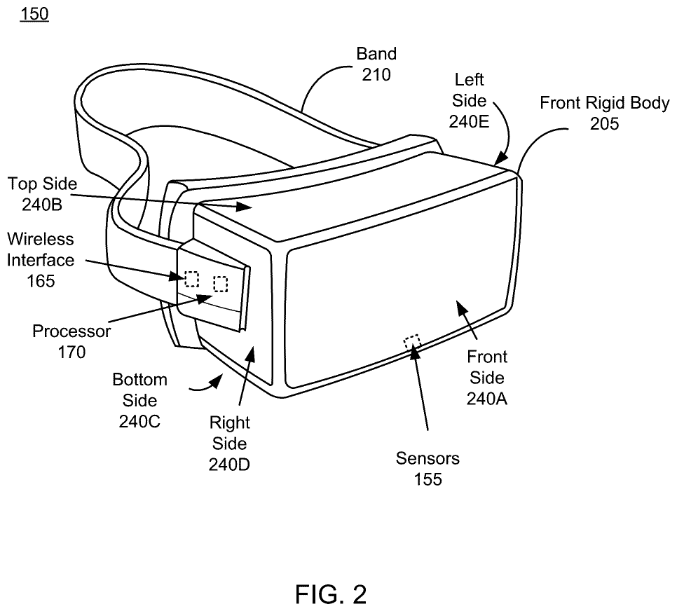

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

In various embodiments, the devices in the environments described above may operate or otherwise use components which leverage communications in the ultra-wideband (UWB) spectrum. In various embodiments, UWB devices operate in the 3-10 GHz unlicensed spectrum using 500+ MHz channels which may require low power for transmission. For example, the transmit power spectral density (PSD) for some systems may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices located in the environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

Some implementations of UWB may focus on precision ranging, security, and for low-to-moderate rate data communication. As UWB employs relatively simple modulation, it may be implemented at low cost and low power consumption. In AR/VR applications (or in other applications and use cases), link budget calculations for an AR/VR controller link indicate that the systems and methods described herein may be configured for effective data throughput ranging from −2 to 31 Mbps (e.g., with 31 Mbps being the maximum possible rate in the latest 802.15.4z standard), which may depend on body loss assumptions

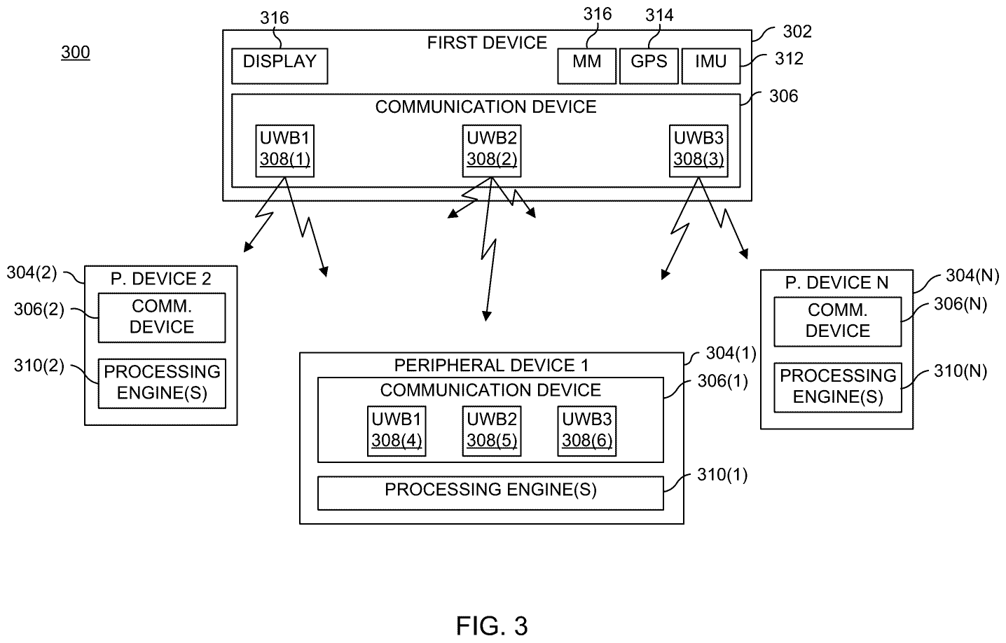

Referring now to FIG. 3, depicted is a block diagram of an artificial reality environment 300. The artificial reality environment 300 is shown to include a first device 302 and one or more peripheral devices 304(1)-304(N) (also referred to as “peripheral device 304,” “second device 304,” or “device 304”). The first device 302 and peripheral device(s) 304 may each include a communication device 306 including a plurality of UWB devices 308. A set of UWB devices 308 may be spatially positioned/located (e.g., spaced out) relative to each other on different locations on/in the first device 302 or the peripheral device 304, so as to maximize UWB coverage and/or to enhance/enable specific functionalities. The UWB devices 308 may be or include antennas, sensors, or other devices and components designed or implemented to transmit and receive data or signals in the UWB spectrum (e.g., between 3.1 GHz and 10.6 GHz) and/or using UWB communication protocol. In some embodiments, one or more of the devices 302, 304 may include various processing engines 310. The processing engines 310 may be or include any device, component, machine, or other combination of hardware and software designed or implemented to control the devices 302, 304 based on UWB signals transmitted and/or received by the respective UWB devices 308.

As noted above, the environment 300 may include a first device 302. The first device 302 may be or include a wearable device, such as the HWD 150 described above, a smart watch, AR glasses, or the like. In some embodiments, the first device 302 may include a mobile device (e.g., a smart phone, tablet, console device, or other computing device). The first device 302 may be communicably coupled with various other devices 304 located in the environment 300. For example, the first device 302 may be communicably coupled to one or more of the peripheral devices 304 located in the environment 300. The peripheral devices 304 may be or include the computing device 110 described above, a device similar to the first device 302 (e.g., a HWD 150, a smart watch, mobile device, etc.), an automobile or other vehicle, a beacon transmitting device located in the environment 300, a smart home device (e.g., a smart television, a digital assistant device, a smart speaker, etc.), a smart tag configured for positioning on various devices, etc. In some embodiments, the first device 302 may be associated with a first entity or user and the peripheral devices 304 may be associated with a second entity or user (e.g., a separate member of a household, or a person/entity unrelated to the first entity).

In some embodiments, the first device 302 may be communicably coupled with the peripheral device(s) 304 following a pairing or handshaking process. For example, the first device 302 may be configured to exchange handshake packet(s) with the peripheral device(s) 304, to pair (e.g., establish a specific or dedicated connection or link between) the first device 302 and the peripheral device 304. The handshake packet(s) may be exchanged via the UWB devices 308, or via another wireless link 125 (such as one or more of the wireless links 125 described above). Following pairing, the first device 302 and peripheral device(s) 304 may be configured to transmit, receive, or otherwise exchange UWB data or UWB signals using the respective UWB devices 308 on the first device 302 and/or peripheral device 304. In some embodiments, the first device 302 may be configured to establish a communications link with a peripheral device 304 (e.g., without any device pairing). For example, the first device 302 may be configured to detect, monitor, and/or identify peripheral devices 304 located in the environment using UWB signals received from the peripheral devices 304 within a certain distance of the first device 302, by identifying peripheral devices 304 which are connected to a shared Wi-Fi network (e.g., the same Wi-Fi network to which the first device 302 is connected), etc. In these and other embodiments, the first device 302 may be configured to transmit, send, receive, or otherwise exchange UWB data or signals with the peripheral device 304.

In some embodiments, the first device 302 may recognize one or more peripheral devices 304 and initiate a communication link. For example, the first device 302 may be preconfigured with peripheral devices 304 identified as reliable, safe, etc.

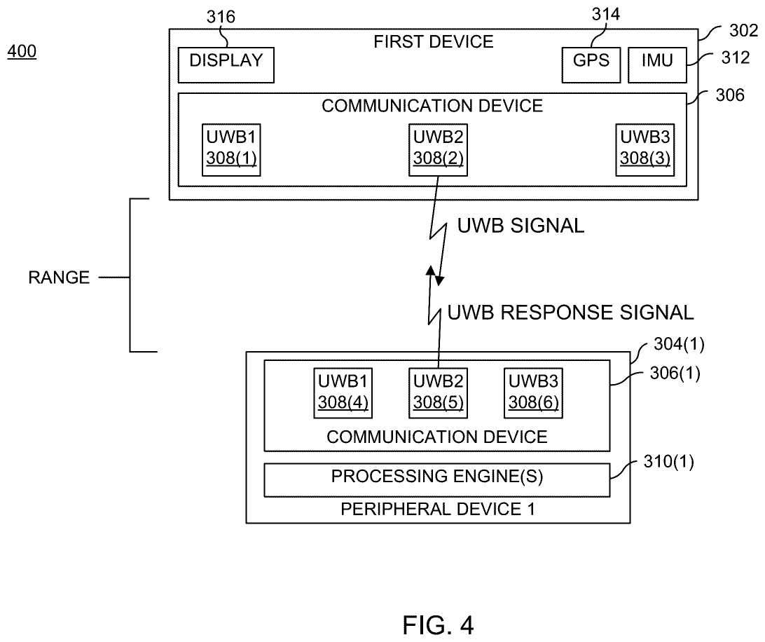

Referring now to FIG. 4, depicted is a block diagram of an environment 400 including the first device 302 and a peripheral device 304. The first device 302 and/or the peripheral device 304 may be configured to determine a range (e.g., a spatial distance, separation) between the devices 302, 304. The first device 302 may be configured to send, broadcast, or otherwise transmit a UWB signal (e.g., a challenge signal). The first device 302 may transmit the UWB signal using one of the UWB devices 308 of the communication device 306 on the first device 302. The UWB device 308 may transmit the UWB signal in the UWB spectrum. The UWB signal may have a high bandwidth (e.g., 500 MHz). As such, the UWB device 308 may be configured to transmit the UWB signal in the UWB spectrum (e.g., between 3.1 GHz and 10.6 GHz) and having a high bandwidth (e.g., 500 MHz). The UWB signal from the first device 302 may be detectable by other devices within a certain range of the first device 302 (e.g., devices having a line of sight (LOS) within 200m of the first device 302). As such, the UWB signal may be more accurate for detecting range between devices than other types of signals or ranging technology.

The peripheral device 304 may be configured to receive or otherwise detect the UWB signal from the first device 302. The peripheral device 304 may be configured to receive the UWB signal from the first device 302 via one of the UWB devices 308 on the peripheral device 304. The peripheral device 304 may be configured to broadcast, send, or otherwise transmit a UWB response signal responsive to detecting the UWB signal from the first device 302. The peripheral device 304 may be configured to transmit the UWB response signal using one of the UWB devices 308 of the communication device 306 on the peripheral device 304. The UWB response signal may be similar to the UWB signal sent from the first device 302.

The first device 302 may be configured to detect, compute, calculate, or otherwise determine a time of flight (TOF) based on the UWB signal and the UWB response signal. The TOF may be a time or duration between a time in which a signal (e.g., the UWB signal) is transmitted by the first device 302 and a time in which the signal is received by the peripheral device 304. The first device 302 and/or the peripheral device 304 may be configured to determine the TOF based on timestamps corresponding to the UWB signal. For example, the first device 302 and/or peripheral device 304 may be configured to exchange transmit and receive timestamps based on when the first device 302 transmits the UWB signal (a first TX timestamp), when the peripheral device receives the UWB signal (e.g., a first RX timestamp), when the peripheral device sends the UWB response signal (e.g., a second TX timestamp), and when the first device 302 receives the UWB response signal (e.g., a second RX timestamp). The first device 302 and/or the peripheral device 304 may be configured to determine the TOF based on a first time in which the first device 302 sent the UWB signal and a second time in which the first device 302 received the UWB response signal (e.g., from the peripheral device 304), as indicated by first and second TX and RX timestamps identified above. The first device 302 may be configured to determine or calculate the TOF between the first device 302 and the peripheral device 304 based on a difference between the first time and the second time (e.g., divided by two).

In some embodiments, the first device 302 may be configured to determine the range (or distance) between the first device 302 and the peripheral device 304 based on the TOF. For example, the first device 302 may be configured to compute the range or distance between the first device 302 and the peripheral device 304 by multiplying the TOF and the speed of light (e.g., TOF×c). In some embodiments, the peripheral device 304 (or another device in the environment 400) may be configured to compute the range or distance between the first device 302 and peripheral device 304. For example, the first device 302 may be configured to transmit, send, or otherwise provide the TOF to the peripheral device 304 (or other device), and the peripheral device 304 (or other device) may be configured to compute the range between the first device 302 and peripheral device 304 based on the TOF, as described above.

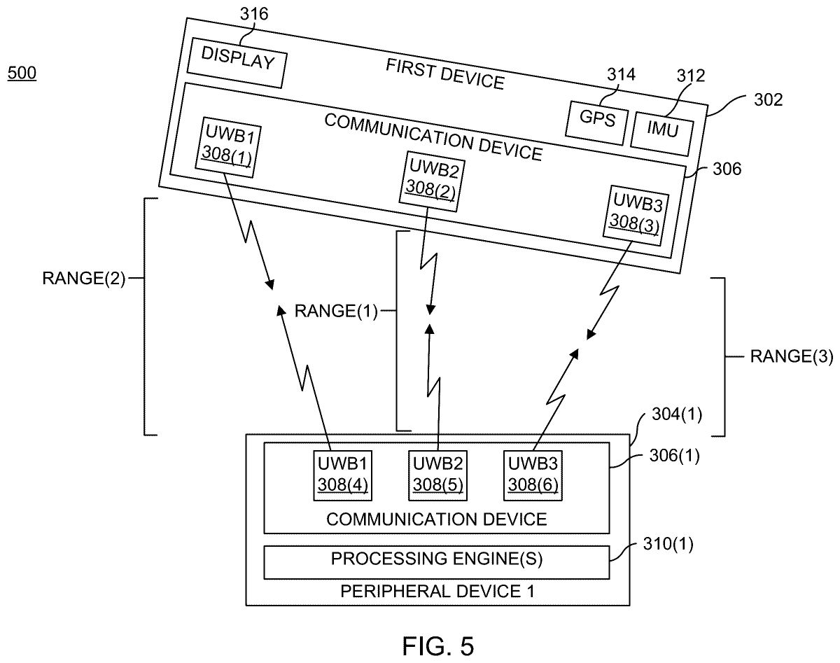

Referring now to FIG. 5, depicted is a block diagram of an environment 500 including the first device 302 and a peripheral device 304. In some embodiments, the first device 302 and/or the peripheral device 304 may be configured to determine a position or pose (e.g., orientation) of the first device 302 relative to the peripheral device 304. The first device 302 and/or the peripheral device 304 may be configured to determine the relative position or orientation in a manner similar to determining the range as described above. For example, the first device 302 and/or the peripheral device 304 may be configured to determine a plurality of ranges (e.g., range(1), range(2), and range(3)) between the respective UWB devices 308 of the first device 302 and the peripheral device 304. In the environment 500 of FIG. 5, the first device 302 is positioned or oriented at an angle relative to the peripheral device 304. The first device 302 may be configured to compute the first range (range(1)) between central UWB devices 308(2), 308(5) of the first and peripheral device 304. The first range may be an absolute range or distance between the devices 302, 304, and may be computed as described above with respect to FIG. 4.

The first device 302 and/or the peripheral device 304 may be configured to compute the second range(2) and third range(3) similar to computing the range(1), In some embodiments, the first device 302 and/or the peripheral device 304 may be configured to determine additional ranges, such as a range between UWB device 308(1) of the first device 302 and UWB device 308(5) of the peripheral device 304, a range between UWB device 308(2) of the first device 302 and UWB device 308(6) of the peripheral device 304, and so forth. While described above as determining a range based on additional UWB signals, it is noted that, in some embodiments, the first device 302 and/or the peripheral device 304 may be configured to determine a phase difference between a UWB signal received at a first UWB device 308 and a second UWB device 308 (i.e., the same UWB signal received at separate UWB devices 308 on the same device 302, 304). The first device 302 and/or the peripheral device 304 may be configured to use each or a subset of the computed ranges (or phase differences) to determine the pose, position, orientation, etc. of the first device 302 relative to the peripheral device 304. Determining the pose, position, orientation, etc. of the first device 302 relative to the peripheral device 304 based on phase differences between UWB signals at the first device 302 and peripheral device 304 may be considered determining the post, position, orientation, etc. according to an angles of arrival (AoA). For example, the first device and/or the peripheral device 304 may be configured to use one of the ranges relative to the first range(1) (or phase differences) to determine a yaw of the first device 302 relative to the peripheral device 304, another one of the ranges relative to the first range(1) (or phase differences) to determine a pitch of the first device 302 relative to the peripheral device 304, another one of the ranges relative to the first range(1) (or phase differences) to determine a roll of the first device 302 relative to the peripheral device 304, and so forth.

By using the UWB devices 308 at the first device 302 and peripheral devices 304, the range and pose may be determined with greater accuracy than other ranging/wireless link technologies. For example, the range may be determined within a granularity or range of +/−0.1 meters, and the pose/orientation may be determined within a granularity or range of +/−5 degrees.

Referring to FIG. 3-FIG. 5, in some embodiments, the first device 302 may include various sensors and/or sensing systems. For example, the first device 302 may include an inertial measurement unit (IMU) sensor 312, global positioning system (GPS) 314, magnetometer (MM) 316, etc. The sensors and/or sensing systems, such as the IMU sensor 312, MINI 316, and/or GPS 314 may be configured to generate data corresponding to the first device 302. For example, the IMU sensor 312 may be configured to generate data corresponding to an absolute position and/or pose of the first device 302. Similarly, the GPS 314 may be configured to generate data corresponding to an absolute location/position of the first device 302. Further, the MINI 316 may be configured to measure magnetic fields and/or magnetic dipoles. The data from the IMU sensor 312, MM 316 and/or GPS 314 may be used in conjunction with the ranging/position data determined via the UWB devices 308 as described above. For example, collecting IMU 312 data and MINI 316 data, in addition to UWB data, may allow the first device 302 to achieve a high sample rate relative to the first device 302 location and/or rotation.

In some embodiments, the first device 302 may include a display 316. The display 316 may be integrated or otherwise incorporated in the first device 302. In some embodiments, the display 316 may be separate or remote from the first device 302. The display 316 may be configured to display, render, or otherwise provide visual information to a user or wearer of the first device 302, which may be rendered at least in part on the ranging/position data of the first device 302.

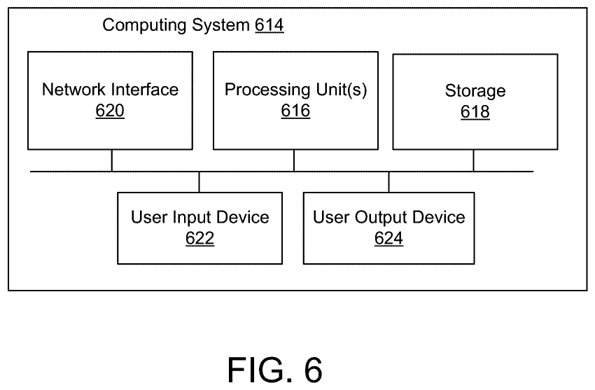

Various operations described herein can be implemented on computer systems. FIG. 6 shows a block diagram of a representative computing system 614 usable to implement the present disclosure. In some embodiments, the computing device 110, the HWD 150, devices 302, 304, or each of the components of FIG. 1-5 are implemented by or may otherwise include one or more components of the computing system 614. Computing system 614 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 614 can be implemented to provide VR, AR, MR experience. In some embodiments, the computing system 614 can include conventional computer components such as processors 616, storage device 618, network interface 620, user input device 622, and user output device 624.

Network interface 620 can provide a connection to a wide area network (e.g., the Internet) to which WAN interface of a remote server system is also connected. Network interface 620 can include a wired interface (e.g., Ethernet) and/or a wireless interface implementing various RF data communication standards such as Wi-Fi, Bluetooth, UWB, or cellular data network standards (e.g., 3G, 4G, 5G, 60 GHz, LTE, etc.).

User input device 622 can include any device (or devices) via which a user can provide signals to computing system 614; computing system 614 can interpret the signals as indicative of particular user requests or information. User input device 622 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 624 can include any device via which computing system 614 can provide information to a user. For example, user output device 624 can include a display to display images generated by or delivered to computing system 614. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 624 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 616 can provide various functionality for computing system 614, including any of the functionality described herein as being performed by a server or client, or other functionality associated with message management services.

It will be appreciated that computing system 614 is illustrative and that variations and modifications are possible. Computer systems used in connection with the present disclosure can have other capabilities not specifically described here. Further, while computing system 614 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

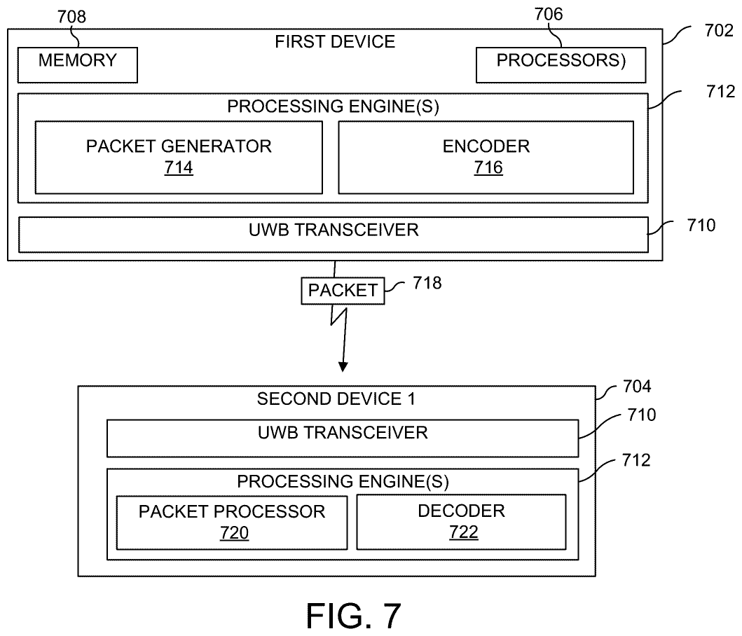

Referring now to FIG. 7, depicted is a block diagram of a system 700 for configuring ultra-wideband physical layer headers, according to an example implementation of the present disclosure. The system 700 may include a first device 702 and any number second devices 704 (referred to generally as a second device 704). The first device 702 may be similar to the first device 302 and the second device 704 may be similar to the peripheral device(s) 304, described above with reference to FIG. 3-FIG. 5. The first device 702 (and second device 704) may include one or more processors 706 and memory 708, which may be similar, respectively, to the processor(s) 118/170 or processing units 616 and storage 618 described above with reference to FIG. 1-FIG. 6. The first device 702 and second device 704 may include respective ultra-wideband (UWB) transceivers 710 and processing engine(s) 712. The UWB transceivers 710 may be similar to the communication device(s) 306, 310 and the processing engine(s) 712 may be similar to the processing engine(s) 310, described above with reference to FIG. 3-FIG. 5.

As described in greater detail below, the first device 702 may be configured to generate/establish a packet (or data frame) 718 including a header and payload. The header may include information indicating a data rate of the payload included in the packet. The first device 702 may be configured to transmit the packet 718 to the second device 704. The second device 704 may receive the packet 718 from the first device 704, determine the data rate based on or according to the information included in the header, and decode the packet 718 for processing or otherwise using the packet 718. While described with reference to packets 718 transmitted from the first device 702 to the second device 704, it should be understood that, in various embodiments, the second device 704 may be configured to generate similar packets which are transmitted to the first device 702. In this regard, the first device 702 may include processing engines 712 similar to those included in the second device 704 (and vice versa).

The first device 702 may include a packet generator 714. The packet generator 714 may be or include any device, component, element, or hardware designed or configured to generate packets 718 for transmission via the UWB transceiver 710. In some embodiments, the packet generator 714 may be at a physical (or hardware) layer of the first device 702. In other words, the packets 718 may be or include physical layer packets or data frames. The packet generator 714 may be configured to generate the packets using, based on, or otherwise according to data queued from an application layer (or other upper-level layer) of the first device 702.

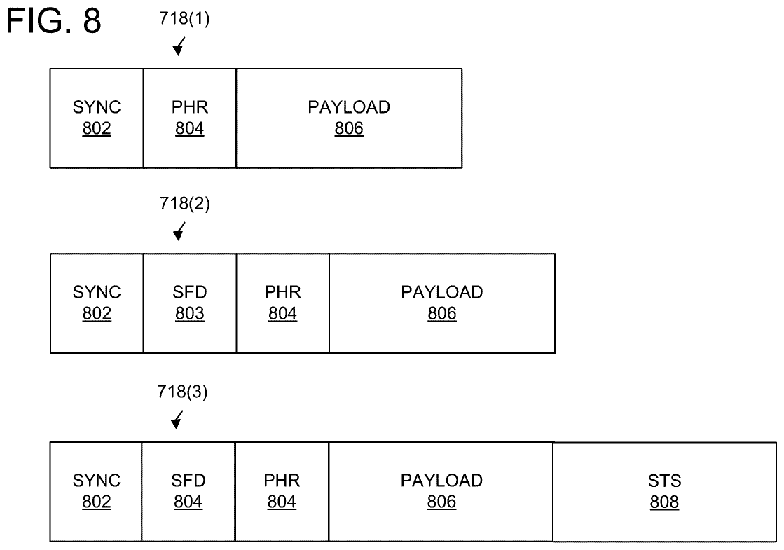

Referring to FIG. 7 and FIG. 8, and in some embodiments, the packets 718 may be or include various packet configurations. The packets may include one or more of the configurations shown in FIG. 8. Specifically, FIG. 8 depicts various examples of packets 718, including a first packet 718(1), a second packet 718(2), and a third packet 718(3). As shown in FIG. 8, the packets 718 may include a synchronization signal or header 802, a physical layer packet header (PHR) 804, and a payload 806. In the second packet 718(2), the packet 718(2) may further include a start of frame delimiter (SFD) 803. In the third packet 718(3), the packet 718(3) may include a scrambled timestamp sequence (STS) 808. The SYNC 802 may provide for synchronization between the transmitting device (e.g., first device 702) and the receiving device (e.g., second device 704). The SFD 803 may separate the SYNC 802 and PHR 804/payload 806, to indicate to the receiving device the start of the PHR 804. The STS 808 may be or include a random sequence of bits used by the transmitting device and receiving device to enhance data integrity of the data packet 718. The header 804 and payload are described in greater detail below.

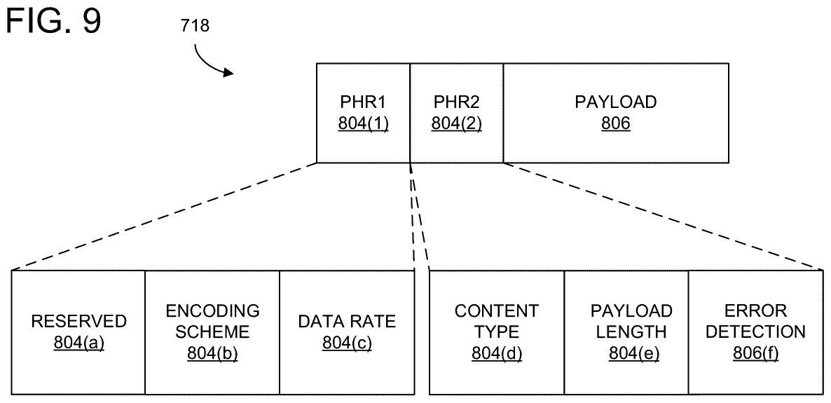

Referring now to FIG. 7 through FIG. 9, the packet generator 714 may be configured to generate, establish, determine, derive, produce, or otherwise provide a header 804 and payload 806 for the packets 718. Specifically, FIG. 9 shows a portion of the packets 718 described above with reference to FIG. 8. In some embodiments, the packet generator 714 may be configured to generate the packets 718 to include a payload using or based on data queued for transmission from the application layer of the device. The packet generator 714 may be configured to generate the payload 806 to include at least a portion of the data/bits/information from the queue. The data may include, for example, ranging or sensing measurements, data (e.g., for data communication), etc. The packet generator 714 may be configured to generate the payload 806 by selecting at least a portion of the data/bits/information from the queue to include as a payload 806 of the packet 718.

In some embodiments, the packet generator 714 may be configured to generate a plurality of headers 804 for the packet. As shown in FIG. 9, the packet 718 may include a first header 804(1) and a second header 804(2). The header(s) 804 may include fields 804(a)-804(f) for providing various information regarding the packet 718. The packet generator 714 may be configured to provide first information relating to or regarding the packet 718 in the first header 804(1) and second information relating to or regarding the packet 718 in the second header 804(2). In some embodiments, the headers 804(1), 804(2) may be configured such that the first information may contain fewer bits than the second information (e.g., fewer bits to encode, which can therefore be sent at a lower data rate while not resulting in being a bottleneck for the packet).

In some embodiments, the headers 804(1), 804(2) may include a reserved field 804(a), an encoding scheme field 804(b), a data rate field 804(c), a content type field 804(d), a payload length field 804(e), and/or an error detection field 804(f). In some embodiments, the reserved field 804(a), the encoding scheme field 804(b), and the data rate field 804(c) may be included in the first header 804(1), and the content type field 804(d), payload length field 804(e), and error correction field 804(f) may be included in the second header 804(2). Each of these fields, and population of such fields, are described in greater detail below.

The first header 804(1) may include a reserved field 804(a). The reserved field 804(a) may be used to provide reserved bits which can be used for various future purposes. For example, the packet generator 714 may be configured to generate/populate the reserved field 804(a) to indicate a version corresponding to the packet (e.g., a version of the packet format or protocol used for generating the packet). The reserved bits could also be used to extend the payload length identified or included in the payload length field 804(b), as needed.

The first header 804(1) may include an encoding scheme field 804(b). The encoding scheme field 804(b) may be or include a number of bits representing, indicating, or otherwise identifying an encoding scheme used (e.g., by the encoder 716) to encrypt, convert, or otherwise encode the packet 718 (e.g., at least the payload 806 of the packet 718). In some embodiments, the packet generator 714 may be configured to populate the encoding scheme field 804(b) based on or according to the encoding scheme set to be used by the encoder 716 to encode the payload 806. For example, where the encoder 716 is a low density parity check (LDPC) encoder 716, and the LDPC encoder 716 is to encode the payload 806, the packet generator 714 may be configured to set/generate/provide one or more bits in the encoding scheme field 804(b) to indicate that the payload 806 is to be encoded using the LDPC encoder 716. In some embodiments, the encoding scheme field 804(b) may be an LDPC enabled field, which is set to high (or “1”) in instances where the packet generator 714 determines that the LDPC encoder 716 is to encode the payload 806. The packet generator 714 may be configured to determine which type or format of encoding is to be used based on negotiated parameters established as part of establishing a session or communication link between the devices 702, 704 (e.g., as described above with reference to FIG. 1-FIG. 5).

The first header 804(1) may include a data rate field 804(c). The data rate field 804(c) may be or include a number of bits representing, indicating, or otherwise identifying a data rate corresponding to the payload 806. In some embodiments, the packet generator 714 may be configured to select the data rate from a plurality of data rates. In some embodiments, the packet generator 714 may be configured to select the data rate by selecting a corresponding modulation coding scheme (MCS) value. In some embodiments, the packet generator 714 may be configured to select the data rate by selecting the MCS value from one of the plurality of MCS values listed in Table 1 below. In some embodiments, each MCS value may have a corresponding data rate and code rate.

TABLE 1
MCS Values and Corresponding Data Rates

| MCS | Data Rates (Mb/s) | Code Rate |
|---|---|---|
| 1 | 1.95 | 1/2 |
| 2 | 7.8 | 1/2 |
| 3 | 31.2 | 1/2 |
| 4 | 62.4 | 1/2 |
| 5 | 124.8 | 1/2 |

As shown in Table 1, the packet generator 714 may be configured to select the MCS value from among an MCS 1-MCS 5, to select a data rate between 1.95 megabits per second (Mb/s) and 124.8 Mb/S. Each MCS value/data rate may have a corresponding code rate. The code rates may be, for example, half of the data rate.

The packet generator 714 may be configured to select the MCS value to provide in the first header 804(1), to provide information indicating the selected data rate. In some embodiments, the packet generator 714 may be configured to select the data rate based on or according to the payload. For example, the packet generator 714 may be configured to select the data rate based on the content type of the payload, based on an amount of data/information/bits in the payload, a selected fidelity/reliability of the payload, etc. As one example, where the amount of data/information/bits included in the payload increases, the packet generator 714 may be configured to select a lower data rate to increase the fidelity/reliability of the payload without significantly compromising the transmission time or packet size. Similarly, as the amount of data/information/bits included in the payload decreases, the packet generator 714 may be configured to select a higher data rate to transmit more data/information/bits in the payload. The packet generator 716 may be configured to set, identify, populate, or otherwise include bits in the data rate field 804(c) to indicate the selected data rate (e.g., to indicate the MCS value, which provides information indicating the selected data date).

In some embodiments, the data rate field 804(c) may indicate, identify, or otherwise provide the selected data rate for the payload 806 and the second header 804(2). For example, the first header 804(1) may be encoded at a first data rate which is different than the second header 804(2) and payload 806. For example, the first header 804(1) may be encoded at a first data rate of 0.78 Mb/s, and the second header 804(2) and payload 806 may be encoded at a different data rate (e.g., determined, set, or otherwise identified by the data rate included in/identified by/indicated by the data rate field 804(c)). The first data rate (e.g., of the first header 804(1) may be fixed, set, preconfigured, predetermined, or otherwise defined for all packets. In some embodiments, the payload 806 may be encoded at the data rate provided in the data rate field 804(c), and the second header 804(2) may be encoded at a data rate which is related to the data rate of the payload 806. For example, the second header 804(2) may be encoded at the same data rate as the payload 806, at a data rate which equal to the data rate of the payload 806, is half the data rate of the payload 806, at a data rate which is ¼ of the data rate of the payload 806, etc. In some embodiments, the proportion of the data rate of the second header 804(2) to the payload 806 may be fixed (e.g., equal, half, quarter, etc. of the payload 806). In some embodiments, the proportion of the data rate of the second header 804(2) to the payload 806 may depend on the encoding scheme used to encode the packet. For example, where the encoding scheme is an LDPC encoding scheme, the proportion may where the data rate of the second header 804(2) is half the data rate of the payload 806 and, where the encoding scheme is a constraint length (CL) 7 encoding scheme, the proportion may be equal where the data rate of the second header 804(2) is equal to the data rate 806. In this regard, by providing the selected data rate and encoding scheme for the payload 806, the receiving device (e.g., second device 704) may be configured to determine or otherwise derive the data rate for the payload of the second header 804(2).

The second header 804(2) may include a content type field 804(d). The content type field 804(d) may be or include a number of bits representing, indicating, or otherwise identifying a content type of the payload 806. In some embodiments, the content type field 804(d) may include bits identifying whether the payload is to be used for ranging and/or sensing. For example, and in some embodiments, the content type field 804(d) may include a bit to indicate whether the payload is to be used for ranging and/or sensing (e.g., set to “1” or high if the payload contains/includes/corresponds to ranging and/or sensing measurements). In some embodiments, the content type field 804(d) may include a first bit to indicate whether the payload is to be used for ranging and a second bit to indicate whether the payload is to be used for sensing (e.g., set to 10 if the payload is to be used for ranging or 01 if the payload is to be used for sensing). While described as being included in a single field, it is noted that, in various embodiments, the second header 804(2) may include a first field for indicating whether the payload is to be used for ranging and a second field for indicating whether the payload is to be used for sensing. The packet generator 714 may be configured to generate/populate the content type field 804(d) based on or according to the information/data included in the payload. In some embodiments, the packet generator 714 may be configured to generate the content type field 804(d) based on the source of the data/information queued at the application layer.

The second header 804(2) may include a payload length field 804(e). The payload length field 804(e) may be or include a number of bits representing, indicating, or otherwise identifying length or number of bits/bytes/octets of the payload 806. The packet generator 714 may be configured to generate/populate the payload length field 804(e) based on or according to payload 806 generated for the packet 718. For example, the packet generator 714 may be configured to determine a size/length/number of bits included in the payload 806, and generate populate the payload length field 804(e) with bits set according to the determined size/length/number of bits.

The second header 804(2) may include an error correction field 804(f). The error correction field 804(f) may be or include a number of bits representing, indicating, or otherwise identifying error correction bits used by the receiving device (e.g., the second device 704) for error correction. In some embodiments, the error correction field 804(f) may include a number of parity bits for the second header 804(2). The packet generator 714 may be configured to generate/determine the number of parity bits to include in the second header 804(2) based on or according to an error correction scheme. For example, the packet generator 714 may be configured to determine the number of parity bits to include in the header 804 (e.g., in the error correction field 804(f) of the header 804) by performing a cyclic redundancy check (CRC) of the header 804. In some embodiments the CRC may be or include an 8-bit CRC. For instance, the packet generator 714 may be configured to compute, derive, or otherwise determine the number of parity bits by computing an 8-bit CRC according to z⁸+z²+z+1. While descried as using a CRC error correction scheme, in various embodiments, the packet generator 714 may additionally or alternatively use a single error correction double error detection (SECDED) error correction scheme.

In some embodiments, the headers 804(1), 804(2) may be repeated in the packet 718. The headers may be repeated any number of times. For example, the packet 718 may include two repetitions. In this regard, the packet 718 may include two instances or repetitions of the first header 804(1) and two instances or repetitions of the second header 804(2).

Referring back to FIG. 7, once the packet generator 714 generates/populates/creates/establishes/derives/produces the header 804 and payload 806 (among other components/elements/fields) of the packet 718, the encoder 716 may be configured to encode the packet 718 for transmission to the second device 704. The encoder 716 may be configured to encode the packet 718 according to the encoding scheme identified by the packet generator 714 in the first header 804(2) (e.g., in the encoding scheme field 804(b)). The encoder 716 may be configured to encode the packet 718 using LDPC. In other words, the encoder 716 may be an LDPC encoder 716 as described above. The encoder 716 may be configured to encode the packet 718 at the corresponding data rates. For example, the encoder 716 may be configured to encode the first header 804(1) at the first data rate, encode the second header 804(2) at a second data rate, and encode the payload 806 at a third data rate (e.g., where the second data rate corresponds to and is indicated by the third data rate of the payload).

The first device 702 may be configured to communicate, send, transmit, or otherwise provide the packet 718 to the second device 704. The first device 702 may be configured to transmit the packet 718 via the UWB transceiver 710 to the second device 704. The first device 702 may be configured to transmit the packet 718 as part of the UWB session established between the devices 702, 704. The second device 704 may be configured to receive the packet 718 via the UWB transceiver 710 from the first device 702.

The second device 704 may include a packet processor 720. The packet processor 720 may be or include any device, component, element, or hardware designed or configured to parse, inspect, analyze, or otherwise process the packet(s) 718 received via the UWB transceiver 710 of the second device 704. In some embodiments, the packet processor 720 may be configured to process the packet(s) 718 to extract data/information from the headers 804 of the packet 718. For example, the packet processor 720 may be configured to identify various information included in the headers of the packet 718, to determine how to process the packet 718. The packet processor 720 may be configured to extract or otherwise identify the payload length, content type, encoding scheme, and/or data rate (e.g., based on the values or bits provided in the payload length field 804(e)), the content type field 804(d), the encoding scheme field 804(b), and data rate field 804(c)). The packet processor 720 may be configured to compute an error detection value based on the received information from the header 804, for comparison to the information included in the error detection field 804(f). The packet processor 720 may be configured to identify any errors in the headers 804 based on, for example, a mismatch in the number of parity bits.

The second device 704 may include a decoder 722. Similar to the encoder, the decoder 722 may be or include any device, component, element, or hardware designed or configured to decrypt, decipher, or otherwise decode the data packet 718. In some embodiments, the decoder 722 may be configured to decode the payload 806 of the data packet. The decoder 722 may be configured to decode the payload 806 according to the encoding scheme and data rate determined by the packet processor 720. For example, the decoder 722 may be configured to determine the data rate (e.g., by performing a look-up using the MCS value indicated in the data rate field 804(c) of the first header 804(1)) and encoding scheme, and use the data rate to decode the second header 804(2) and the payload 806 using a decoding scheme corresponding to the encoding scheme. For instance, where the MCS value specified in the data rate field 804(c) is set to 4 and the encoding scheme indicated in the encoding scheme field 804(b) indicates LDPC was used for encoding the packet 718, the decoder 722 may be configured to decode the packet 718 using an LDPC decoder, and decode the second header 804(2) at a data rate of 31.2 Mb/s (e.g., half the data rate of the payload 806) and decode the payload at a data of 62.4 Mb/s. As another example, where the MCS value specified in the data rate field 804(c) is set to 4 and the encoding scheme indicated in the encoding scheme field 804(b) indicates CL7 was used for encoding the packet 718, the decoder 722 may be configured to decode the packet 718 using an CL7 decoder, and decode both the second header 804(2) and the payload at a data rate of 62.4 Mb/s.

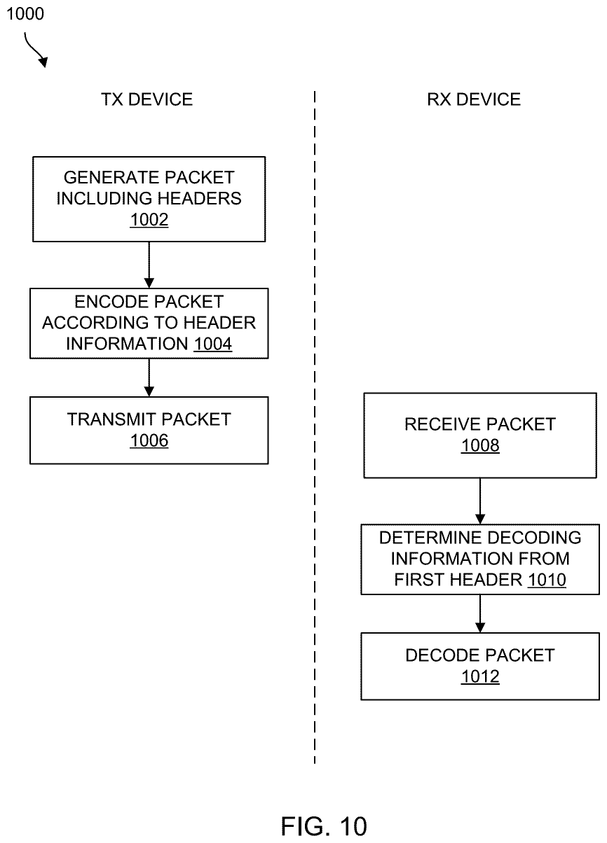

Referring now to FIG. 10, depicted is a flowchart showing an example method 1000 of configuring reduced repetitions for UWB physical layer headers, according to an example implementation of the present disclosure. The method 1000 may be performed, implemented, or otherwise executed by the devices, elements, hardware, or components described above with reference to FIG. 1-FIG. 9. As a brief overview, at step 1002, a first device may generate a packet including headers. At step 1004, the first device may encode the packet according to header information. At step 1006, the first device may transmit the packet to a second device. At step 1008, the second device may receive the packet. At step 1010, the second device may determine decoding information from the first header. At step 1012, the second device may decode the packet.

At step 1002, a first device may generate a packet including headers. The first device may be or include a first ultra-wideband (UWB) device. For example, the first device may be a device which includes a UWB transceiver, the first device may be a UWB transceiver, etc. In some embodiments, the first device may generate a packet including a first header and a second header. The first header may include a plurality of bits indicating a data rate and an encoding scheme of a payload of the packet. The first device may generate packets at various intervals (e.g., periodically). The first device may generate packets on demand (e.g., responsive to the data/information/bits corresponding to the payload being queued for transmission to a second device). The first device may generate the packet as a scrambled timestamp sequence (STS), or any other UWB packet.

The first device may generate a first and second header for the packet. The first device may provide various information relating to the packet in respective headers of the packet. In some embodiments, the first device may generate the first header to include information relating to the data rate and an encoding scheme of the packet. The first device may generate the second header to include information or bits relating to a payload length, a content type, and error detection bits. The first device may generate the first header to include less information than the second header. In this regard, the first header may be encoded or otherwise provided at a lower data rate than the second header, to provide a more robust first header without causing a bottleneck at the receiving device (e.g., the second device).

In some embodiments, the first device may select a data rate for the packet. The first device may select the data rate from a plurality of data rates. For example, the first device may select the data rate from a plurality of data rates between 1.95 megabits per second (Mb/s) and 124.8 Mb/s. In some embodiments, the first device may select the data rate based on or according to the payload. The first device may select the data rate according to an amount/selected fidelity/etc. of the payload. For example, the first device may select lower data rates to provide more reliable payloads. The first device may select the data rate by selecting a modulation and coding scheme (MCS) value. For example, the first device may maintain a table or ledger of MCS values and corresponding data rates. The first device may select the MCS value which corresponds to the selected data rate.

The first device may determine a content type of the payload of the packet. For example, the first device may determine the content type as a ranging content type, a sensing content type, a data communication content type, or any other content type. The first device may determine the content type based on or according to a source of the data/information/bits included in the payload (e.g., from the application layer). The first device may determine a payload length of the payload. The first device may determine, compute, identify, or otherwise quantify the payload length responsive to determining or otherwise establishing the payload which is to be included in the packet. For example, the first device may quantify the payload length by counting a number of bits, bytes, octets, etc. included in the payload responsive to establishing the payload. The first device may determine an encoding scheme to be used for encoding the packet. In some embodiments, the first device may determine the encoding scheme based on or according to negotiated parameters of a session between the first device and the second device (e.g., responsive to or as part of establishing the session). In some embodiments, the encoding scheme may be preconfigured or preset for the first device. The first device may determine the encoding scheme to be, for example, a low density parity check (LDPC) encoding scheme and/or constraint length 7 (CL7) encoding scheme. The first device may determine a version of the packet. In some embodiments, the first device may determine the version based on or according to various settings of the first device (e.g., indicating an internet protocol (IP) version or some other version) for generating the packet.

The first device may generate the first header and the second header based on the information described above. In some embodiments, the first device may generate the first header by populating information relating to the version, data rate, and/or encoding scheme in corresponding fields of the first header. The first device may generate the second header by populating information relating to the content type, payload length, etc. in corresponding fields of the second header.

The first device may compute, determine, identify, or otherwise provide a number of error detection bits in a corresponding field of the second header. In some embodiments, the error detection bits may be or include parity bits. The first device may compute, determine, or otherwise derive the number of parity bits responsive to populating the header(s). In some embodiments, the first device may determine the number of parity bits to include in the second header according to an 8-bit cyclic redundancy check function.

In some embodiments, responsive to generating the first and second headers (e.g., by populating the headers with corresponding information determined by the first device relating to the packet), the first device may generate one or more repetitions of the first and second headers. The first device may repeat the headers any number of times. For example, the packet may include two repetitions of the first header and two repetitions of the second header.

At step 1004, the first device may encode the packet according to header information. In some embodiments, the first device may encode the packet according to the header information included in the first header. For example, the first device may encode the packet according to the data rate and the encoding scheme identified in or otherwise indicated by the first header. For instance, the first device may encode the payload of the packet using the selected encoding scheme (e.g., LDPC, CL7, etc.) at the data rate selected for the data packet. In some embodiments, the first device may encode the headers at a rate which is different than the data rate identified in the first header. For example, the first device may encode the first header at a fixed (or predetermined, preconfigured, set, established) data rate, and may encode the second header at a data rate which corresponds to the data rate used to encode the payload. In some embodiments, the first device may encode the first header at the fixed data rate. The first device may encode the second header at a second data rate which is proportional to or otherwise corresponds to a third data rate used to encode the payload. The second data rate may be equal to or one half of the third data rate. In some embodiments, the proportion of the second and third data rates may be fixed (e.g., to one half). In some embodiments, the proportion of the second and third data rates may depend on the encoding scheme used for encoding the packet (e.g., one-to-one data rate where CL7 is used, or ½ where LDPC is used). In some embodiments, the proportion of the second and third data rates may be signaled in the first header (e.g., in the reserved field, in another data rate field, etc.).

At step 1006, the first device may transmit the packet. In some embodiments, the first device may transmit the packet to a second device. The first device may transmit the data frame (or packet) to the second device via respective UWB transceivers of the first and second device. The first device may transmit the second device during a UWB session with the second device. The first device may transmit the second device responsive to generating and encoding the packet and headers as described above. At step 1008, the second device may receive the packet. In some embodiments, the second device may receive the packet including the first and second headers encoded and including the information as described above.

At step 1010, the second device may determine decoding information from the first header. In some embodiments, the second device may determine the decoding information from the first header by decoding the first header according to the fixed data rate and using a known decoding scheme. The second device may extract, for example, the data rate and encoding scheme from the first header (e.g., based on analysis of the bits included in the first header indicating the data rate and encoding scheme).

At step 1012, the second device may decode the packet. In some embodiments, the second device may decode the packet according to the encoding scheme and the data rate. The second device may decode the second header and the payload according to the encoding scheme and data rate. In some embodiments, the second device may decode the second header using a decoder corresponding to the encoding scheme, where the second header is decoded at a data rate which corresponds to the data rate included in the first header. The second device may decode the second header according to the proportion (e.g., which is known or signaled in the first header) of the data rate of the second header to the data rate identified for the payload. The second device may decode the second header, to determine the payload length and content type identified in the second header. The second device may compute a number of error detection bits responsive to decoding the first and second header. The second device may compare the computed number of error detection bits to the error detection bits included in the second header. The second device may determine, detect, or otherwise identify any errors in the headers based on the comparison (e.g., based on a mismatch in the number of parity bits). The second device may decode the payload responsive to determining that the headers do not include errors (e.g., the number of parity bits computed for the headers matching the number of parity bits included in the second header). The second device may decode the payload according to the encoding scheme and data rate identified in the first header. For example, the second device may decode the payload of the packet using a decoder corresponding to the indicated/identified encoding scheme, and decode the payload at the data rate identified in the first header. The second device may decode the payload for consumption/use at the second device.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
generating, by a first ultra-wideband (UWB) device, a packet including a first header and a second header, the first header including a plurality of bits indicating a data rate and an encoding scheme of a payload of the packet; and
transmitting, by the first UWB device, the packet to a second UWB device.

2. The method of claim 1, wherein the plurality of bits indicate whether low density parity check (LDPC) or constraint length 7 (CL7) encoding scheme is used by the first UWB device.

3. The method of claim 1, wherein the plurality of bits indicate the data rate of the payload and the second header.

4. The method of claim 1, wherein the packet includes two repetitions of the first header and the second header.

5. The method of claim 1, wherein the first header is encoded at a data rate which is different than the data rate of the payload indicated by plurality of bits.

6. The method of claim 1, wherein the second header is encoded at a data rate which is half of the data rate of the payload indicated by the plurality of bits.

7. The method of claim 1, further comprising selecting, by the first UWB device, the data rate for encoding the payload.

8. The method of claim 7, wherein the data rate is selected from a range of data rates between 1.95 Mb/s and 124.8 Mb/s.

9. The method of claim 1, wherein the second header comprises one or more bits indicating whether the packet is to be used for sensing or ranging.

10. The method of claim 1, wherein the second header comprises one or more bits indicating a payload length of the payload and a plurality of parity bits, wherein a number of the plurality of parity bits is determined according to an 8-bit cyclic redundancy check.

11. A first device comprising:
an ultra-wideband (UWB) transceiver configured to:
generate a packet including a first header and a second header, the first header including a plurality of bits indicating a data rate and an encoding scheme of a payload of the packet; and
transmit the packet to a second UWB device.

12. The first device of claim 11, wherein the plurality of bits indicate whether low density parity check (LDPC) or constraint length 7 (CL7) encoding scheme is used by the first device.

13. The first device of claim 11, wherein the plurality of bits indicate the data rate of the payload and the second header.

14. The first device of claim 11, wherein the packet includes two repetitions of the first header and the second header.

15. The first device of claim 11, wherein the first header is encoded at a data rate which is different than the data rate of the payload indicated by plurality of bits.

16. The first device of claim 11, wherein the second header is encoded at a data rate which is half of the data rate of the payload indicated by the plurality of bits.

17. The first device of claim 11, wherein the UWB transceiver is further configured to select the data rate for encoding the payload.

18. The first device of claim 17, wherein the data rate is selected from a range of data rates between 1.95 Mb/s and 124.8 Mb/s.

19. The first device of claim 10, wherein the second header comprises one or more first bits indicating whether the packet is to be used for sensing or ranging, one or more second bits indicating a payload length of the payload, and a plurality of parity bits, wherein a number of the plurality of parity bits is determined according to an 8-bit cyclic redundancy check.

20. A first ultra-wideband (UWB) transceiver comprising:
one or more processors configured to:
receive, from a second UWB transceiver, a packet including a first header and a second header, the first header including a plurality of bits indicating a data rate and an encoding scheme of a payload of the packet; and
decode the packet according to the encoding scheme and the data rate.
